(19) United States
(12) Patent Application Publication
(10) Pub. No.: US 2025/0153193 A1
(43) Pub. Date: May 15, 2025

(54) CONTINUOUS FLOW CENTRIFUGE AND COMPENSATION ROTOR GUIDING DEVICE

(71) Applicant: Sartorius Stedim North America Inc., Bohemia, NY (US)

(72) Inventor: Michael Sander, Osterode (DE)

(73) Assignee: Sartorius Stedim North America Inc., Bohemia, NY (US)

(21) Appl. No.: 19/022,767

(22) Filed: Jan. 15, 2025

Related U.S. Application Data
(63) Continuation of application No. PCT/EP2023/071662, filed on Aug. 4, 2023.

(30) Foreign Application Priority Data
Aug. 9, 2022 (EP) 22 189 563.4

(51) Int. Cl. B04B 5/12; B04B 5/04; B04B 11/02

(52) U.S. Cl. CPC B04B 5/12; B04B 5/0442; B04B 11/02

(57) ABSTRACT

A continuous flow centrifuge comprising a rotor comprising at least one centrifugation chamber and which is rotated about a rotor axis at a rotor speed, and a connecting section through which connecting conduits extend. A medium can be supplied to the centrifugation chamber via the connecting conduits during operation, and the medium can be discharged from the centrifugation chamber. One end section of the connecting section is fixed to the housing, while the other end section is rotated with the rotor. To avoid twisting of the connecting section, the connecting section is guided in a compensating rotor guiding device, which is rotated about the rotor axis at half the rotor speed. The compensating rotor guiding device may comprise a guiding contour whose radius of curvature in a first guiding contour section is larger than the radius of curvature in a second guiding contour section.

### CROSS REFERENCE TO RELATED APPLICATIONS

This application is a continuation of International Application PCT/EP2023/071662 with an international filing date of Aug. 4, 2023 and claiming priority to co-pending European Patent Application No. EP 22 189 563.4 entitled “Durchflusszentrifuge und Ausgleichsrotor-Fuhrungseinrichtung”, filed on Aug. 9, 2022, the disclosures of which are hereby incorporated herein by reference in their entirety.

### FIELD OF THE INVENTION

The invention relates to a continuous flow centrifuge in which at least one medium (in particular a fluid, a liquid, a suspension and the like) is supplied at least temporarily to a centrifugation chamber and/or a medium is discharged from the centrifugation chamber while the centrifugation chamber is rotating. The medium can be arranged in a receptacle in the centrifugation chamber. The at least one medium is, in particular, the medium to be centrifuged, a rinsing liquid, a washing or buffer solution, a modified medium extracted from the centrifuged medium and/or a sediment in the centrifugation chamber.

To give only a few non-limiting examples of the invention, the continuous flow centrifuge may be a blood centrifuge in which the medium to be centrifuged is blood and the extracted modified medium or sediment is blood cells or particles, or a continuous flow centrifuge by means of which cells, microcarriers or other particles contained in the medium are to be extracted from a medium. It is also possible that the centrifuged medium is not a pure liquid, but a solution or suspension containing particles such as cells, cell debris or -particles, etc.

The continuous flow centrifuge is used, for example, for the production of biopharmaceutical products in biopharmaceutical companies or in bioprocessing applications. The continuous flow centrifuge can be used, for example, for the extraction and/or clarification of cells or microcarriers, whereby the cells obtained in this way can also be used for cell therapy. Another field of application for the continuous flow centrifuge is, for example, the production of vaccines.

The invention also relates to a compensating rotor guiding device.

### BACKGROUND OF THE INVENTION

Continuous flow centrifuges of this type are marketed, for example, by the company Sartorius AG, Otto-Brenner-Strafße 20, 37079 Göttingen, Germany, and affiliated companies under the marking “Ksep” (registered trademark). On the website
www.sartorius.com/en/products/process-filtration/cell-harvesting/ksep-systems
(Date of inspection: 06.07.2022)
relating to these continuous flow centrifuges the functional principle of a continuous flow centrifuge (as it can also be used for the present invention) is described on the basis of a linked video as follows:

A rotor of the continuous flow centrifuge comprises any number (e.g. two or four) of centrifugation chambers, which can be embodied as blood bags held on a rotor body and which are evenly distributed around the circumference. The centrifugation chambers are arranged at equal radial distances from the axis of rotation of the rotor. A first connecting conduit opens at a radial inner location into a centrifugation chamber, while a second connecting conduit opens at a radial outer location into the centrifugation chamber. In a first operating phase, a first medium embodied as blood, for example, is supplied to the centrifugation chamber via the second connecting conduit while the centrifugation chamber rotates with the rotor. In the centrifugation chamber, particles contained in the blood (e.g. blood cells) are deposited radially on the outside as a result of the centrifugation, while the residual medium (i.e. the medium supplied radially on the outside reduced by the particles pushed radially outwards) is discharged from the centrifugation chamber via the first connecting conduit at a radial inner location. In this first operating phase, the first connecting conduit is therefore a discharge conduit, while the second connecting conduit is a supply conduit. As this operation continues, the proportion of particles and their concentration in the centrifugation chamber increases until the chamber is largely and finally completely filled with the particles. In a subsequent optional second operating phase, the particles are washed in the centrifugation chamber. For this purpose, a washing or buffer solution is fed into the centrifugation chamber via the second connecting conduit. The washing or buffer solution rinses through the centrifugation chamber and is discharged at a radial inner location via the first connecting conduit. In this operating phase, the centrifugation chamber also rotates with the rotor so that the particles are prevented from exiting the centrifugation chamber together with the washing or buffer solution via the first connecting conduit due to the centrifugation force. Also during the second operating phase, the first connecting conduit serves as a discharge conduit for the washing or buffer solution, while the first connecting conduit serves as a supply conduit for the washing or buffer solution. In a subsequent third operating phase, the centrifugation chamber continues to rotate with the rotor. In the third operating phase, the direction of flow through the centrifugation chamber is reversed and the particles are removed from the centrifugation chamber via the second connecting conduit, while washing or buffer solution can be re-fed into the centrifugation chamber via the first connecting conduit. The third operating phase ends when all particles have been removed from the centrifugation chamber. This can be followed by successive further cycles with the three operating phases described above.

EP 3 936 601 A1 (corresponding to US patent application US 2023/0250384 A1) shows the design of a medium network which is connected to the connecting conduits and provides the different operating phases. With regard to this medium network, the pump arrangement contained therein, the process control unit, an additional filter arrangement, receptacles for the different media and with regard to the process sequence, reference is also made to EP 3 936 601 A1, EP 2 310 486 B1 (corresponding to U.S. Pat. No. 9,090,910 B2, U.S. Pat. No. 9,279,133 B2 and U.S. Pat. No. 10,208,283 B2) and EP 2 485 846 B1.

EP 2 485 846 B1 (corresponding to U.S. Pat. No. 9,839,920 B2 and U.S. Pat. No. 10,888,878 B2) describes that in continuous flow centrifuges fluidic connections to connecting conduits rotating with the rotor by means of rotary feedthroughs can be problematic, as the rotary feedthroughs are susceptible to leaks and entail the risk of unwanted contamination of the media. On the other hand, it is explained that according to U.S. Pat. Nos. 4,216,770, 4,419,089, 4,389,206 and 5,665,048 connecting sections are used into which the connecting conduits can be integrated. One end section of the connecting section is fixed to the housing, while the other end section of the connecting section is attached to the rotor and is rotated with the rotor. In order to prevent the twisting of the connecting section from increasing as a result of the rotation of the rotor and the relative rotation of the end sections of the connecting section, the connecting section is additionally guided in a compensating rotor guiding device embodied as a guiding tube. The guiding tube has a subsection comprising the shape of a rounded U with side legs of different lengths that are slightly spread apart. The opening of the U points in the direction of the rotor's axis of rotation. Starting from the end section fixed to the housing and bending outwards, the connecting section enters a side leg of the U. In the U-shaped subsection, the connecting section is guided around the rotor by the guiding tube. The free end section of the other side leg of the U of the guiding tube is curved back in a way such that it is arranged coaxially to the axis of rotation of the rotor and is arranged directly adjacent to the entry of the connecting section into the rotor. The guiding tube is then driven at half the speed of the rotor. EP 2 485 846 B1 refers to U.S. Pat. No. 3,586,413 for an explanation of how to avoid increasing twisting of the connecting section by using the rotating guiding tube.

Further prior art is known from EP 1 295 642 A1 (corresponding to U.S. Pat. No. 6,716,154 B2) and U.S. Pat. No. 6,705,983 B1.

### SUMMARY OF THE INVENTION

With the new invention it is possible to propose a continuous flow centrifuge and a compensating rotor guiding device for a continuous flow centrifuge which is improved in terms of stresses and fatigue strength.

The invention relates to a continuous flow centrifuge. The continuous flow centrifuge comprises a rotor which has (at least) one centrifugation chamber. The medium to be centrifuged can be arranged in the centrifugation chamber directly or in a suitable receptacle and the centrifugation chamber can be rinsed with other media such as a washing or buffer solution. In the continuous flow centrifuge, the rotor is rotated around the rotor axis at a rotor speed. The continuous flow centrifuge comprises a connecting section or connecting section (in the following connecting section). The connecting section comprises a connecting conduit via which a medium can be supplied to the centrifugation chamber (in particular to a receptacle arranged in the centrifugation chamber) during operation of the continuous flow centrifuge with a rotating rotor. Furthermore, the connecting section comprises a connecting conduit via which a medium can be discharged from the centrifugation chamber (in particular from a receptacle arranged in the centrifugation chamber). Depending on the actual operating phase, the flow directions through the connecting conduits can be reversed. One end section of the connecting section is fixed to the housing, while the other end section of the connecting section is rotated together with the rotor. In order to avoid twisting of the connecting section, the connecting section is rotated together with a compensating rotor, the connecting section being guided in a compensating rotor guiding device of the compensating rotor, in particular a guiding tube. The compensating rotor and the compensating rotor guiding device are rotated around the rotor axis at half the rotor speed. In this respect, the continuous flow centrifuge can for example be embodied as the flow centrifuge centrifuges according to the prior art mentioned at the beginning.

In conventional continuous flow centrifuges, the connecting section consists of a flexible tube or hose (preferably a corrugated tube) through which the connecting conduits extend. It is quite possible that the cost of such a connecting section with the connecting conduits and the interfaces to the rotor on the one hand and to the medium network on the other hand will be in the range of € 5,000 to € 15,000. Due to the high stresses biasing the connecting section during operation of the continuous flow centrifuge, it may be necessary to replace the connecting section after just 5 to 20 operating hours, which on the one hand leads to long changeover times and downtimes of the continuous flow centrifuge and on the other hand causes considerable costs. Since it is generally not possible to extend the operating life of the connecting section by reducing the rotational speed of the rotor or increasing the dimensions of the connecting section and/or selecting high-strength materials for the connecting section, such short lifetimes of the connecting section are accepted in the state of the art.

The stresses acting on the connecting section during operation of the continuous flow centrifuge have been investigated. The investigations led to the conclusion that the connecting section in the flow centrifuge is subjected to complex stresses:
a) The connecting section performs a relative rotational movement around the longitudinal axis in the compensating rotor guiding device. This relative rotational movement leads to friction between the connecting section and the compensating rotor guiding device. This friction leads to a variable torsional stress on the connecting section over the longitudinal extension of the connecting section. In addition, the friction between the connecting section and the inner wall of the compensating rotor guiding device leads to heat input into the connecting section in the area of the contact surfaces and friction surfaces and (under certain circumstances) to wear.
b) The connecting section is guided in the compensating rotor guiding device in such a way that the connecting section, following a first guiding contour section of the compensating rotor guiding device, is curved outwards from the end section fixed to the housing and the coaxial arrangement there relative to the rotor axis. From a turning point, the connecting section in a second guiding contour section of the compensating rotor guiding device is then curved in the opposite direction until the connecting section with a section oriented parallel to the rotor axis is able to pass the rotor at a radial outward position. The connecting section is thus guided in the aforementioned guiding contour sections corresponding to an elongated S, the two ends of the S being oriented parallel to each other and one end being arranged coaxially to the rotor axis, while at the other end the connecting section has its maximum distance from the rotor axis. The connecting section is curved in the compensating rotor guiding device in accordance with the guiding contours of the aforementioned guiding contour sections and is thus subjected to a bend from its elongated initial position.

As a result of the mechanical boundary conditions of the connecting section, namely
the attachment of an end section of the connecting section to the stationary housing,
the attachment of the other end section of the connecting section to the rotor, which rotates at the rotor speed and
the guidance of the connecting section in the compensating rotor guiding device, which is rotated at half the rotor speed,
the bending of the connecting section is not stationary, but is a rotating bending. Remote from an (imaginary) neutral fiber, a temporary radially outer material area of the connecting section (in particular the flexible hose or the flexible (corrugated) tube) is alternately subjected to a stress alternating with a harmonical course (so alternating tensile and compressive stresses) as a result of the rotating bending.

c) If the connecting section comprises a corrugated tube, the rotating bending of the corrugated tube can cause corrugations or ribs of the corrugated tube to come into contact with each other on the radially inner side of the curved guiding contour, which can lead to a non-linearity in the stiffness of the corrugated tube, which leads to a changed stressing mechanism of the corrugated tube.

d) Considerations have led to the result that a centrifugal force acts on longitudinal sections of the connecting section (in particular the hose or the (corrugated) tube and the conduits arranged therein and also on the medium arranged in the conduits), the amount of which depends on the distance of the respective longitudinal section from the rotor axis. In this case, the centrifugal force acting on the respective longitudinal section comprises
a first component which acts in the direction of the guide surface of the compensating rotor guiding device and thus increases the contact force and friction between the connecting section and the compensating rotor guiding device,
and a second component, which is oriented in the longitudinal direction of the connecting section and leads to a tensile or compressive force in the longitudinal direction of the connecting section.

The distribution of the centrifugal force between the two components results from the trigonometric functions as a function of the angle at which the longitudinal section is inclined relative to the rotor axis.

In the first guiding contour section, the second component leads to a pulling force that results in an elongation of the connecting section, while in the second guiding contour section the second component leads to a compressive force that compresses the connecting section.

In this case, a pulling force due to the centrifugal force in a first material area of the connecting section at a first coordinate of the longitudinal extension of the connecting section, which comprises a small distance from the rotor axis, may be greater than the pulling force due to the centrifugal force in a second material area of the connecting section at a second coordinate of the longitudinal extension of the connecting section, which comprises a greater distance from the rotor axis. The reason for this is that a longer section of the connecting section is arranged radially outwards from the first material area of the connecting section at the first coordinate of the longitudinal extension of the connecting section, which can lead to a greater pulling force as a result of the centrifugal force.

e) Depending on the acting stresses, the boundary conditions in the connecting section may change. For example, an elongation of a connecting conduit in the hose or (corrugated) tube can lead to the connecting conduit no longer being in contact with the inner surface of the hose or (corrugated) tube, which means that the hose or (corrugated) tube is no longer supported internally and the internal friction of the connecting section changes. It is also possible that as a result the longitudinal and/or bending stiffness of the connecting section changes.

f) Any elasticity of the medium in the conduits of the connecting section can be of further significance, as the centrifugal force can lead to pressure changes inside the connecting conduits as a result of the elasticity to an associated change in mass distribution and/or to a change in stiffness.

Against the background of these considerations, the investigation of the above-described biases of the connecting section and the experiments, one embodiment proposes that a compensating rotor guiding device is used in a continuous flow centrifuge comprising a guiding contour whose radius of curvature is greater at a location with a first distance from the rotor axis than at a location with a second distance from the rotor axis, the first distance being smaller than the second distance.

This is to be explained using the simplifying example (which does not limit the invention) wherein the guiding contour is embodied as an S which is elongated in the horizontal direction and which comprises a lower left end section, which is oriented coaxially to the rotor axis, and an upper right end section, which is oriented parallel to the rotor axis. In the middle between these end sections there is a turning point, in the area of which the curvature mathematically changes sign. For this simplified example, in the first guiding contour section between the lower left end section and the turning point the radius of curvature is constant being a first radius of curvature, while in the second guiding contour section between the turning point and the upper right end section the radius of curvature is constant being a second radius of curvature, whereby the second radius of curvature is smaller than the first radius of curvature.

In the first guiding contour section, the cross-sections are subjected to a rotating bending stress at the respective coordinates of the longitudinal extension as a result of the rotating bending, the amount of which can be constant over the longitudinal extension in the first guiding contour section, but changes its sign according to the rotation with a harmonic progression. Superimposed on this rotating bending stress is the tensile stress, which results from the mass of the connecting section due to the centrifugal force corresponding to the distance from the rotor axis and which is quadratically dependent on the rotational speed. At the first end of the first guiding contour section, where the bending starts from the coaxial alignment to the rotor axis, the centrifugal force (which is generated by the entire subsection of the connecting section in the first guiding contour section and possibly also a subsection in the second guiding contour section) is present. For coordinates of the longitudinal extension in the first guiding contour section with a greater distance from the rotor axis, the pulling force being effective in the cross-section at the coordinate of the longitudinal extension as a result of the centrifugal force is reduced, so that the pulling force due to the centrifugal force and the resulting tensile stress is at a maximum at the first end. In the cross-sections at the respective coordinates of the longitudinal extension, the rotating bending stress and the tensile stress due to the centrifugal force are then superimposed. If the rotating bending temporarily leads to a rotating bending compression stress, the superposition with the tensile stress due to the centrifugal force results in a reduction of the resulting stress, which is advantageous for the material stress. A short time later, however, the same cross-sectional area is also subjected to a rotating bending tensile stress due to the further rotating bending, so that the superposition with the tensile stress due to the centrifugal force then leads to an addition of the amounts of the rotating bending tensile stress and the tensile stress due to the centrifugal force. This results in an increased maximum of the resulting stress, which might be responsible for the limitation of the service life of the connecting section according to one possible attempt for an explanation.

One embodiment allows the maximum resulting stress to be reduced, which can increase the service life (possibly significantly):

In the region of the rotor axis or adjacent to it, the radius of curvature is selected to be larger. By increasing the radius of curvature, the amplitude of the rotating bending stress is reduced, which can then lead to a reduction in the maximum resulting stress and thus to a reduction in the stress despite of the superimposition with the tensile stress due to the centrifugal force as explained.

According to one embodiment, the guiding contour comprises a first guiding contour section and a second guiding contour section. For the aforementioned example, the guiding contour sections can each be embodied as a quarter circle with curvatures in opposite directions, in which case the guiding contour sections comprising different radii. However, it is also quite possible that in at least one guiding contour section there are guiding contour section parts with different radii of curvature, whereby the radius of curvature can vary in steps or even continuously. For this proposal, the guiding contour section comprises a curvature in a first direction, while the second guiding contour section comprises a curvature in a second direction. The first guiding contour section and the second guiding contour section are preferably connected to each other by an intermediate section that is oriented radially to the rotor axis. For the example explained at the beginning with the quarter-circular guiding contour sections, the intermediate section can be formed by the local connection point of the ends of the guiding contour sections facing each other, although it is also possible that a straight, preferably radially oriented intermediate section extends between these ends. Alternatively or cumulatively, it is possible that the first guiding contour section and the second guiding contour section are connected to each other via a turning section in which the curvature changes sign. The first guiding contour section has a smaller distance from the rotor axis than the second guiding contour section. In the first guiding contour section, the radius of curvature is larger than the radius of curvature in the second guiding contour section. To mention only a few non-limiting examples, the radius of curvature in the first guiding contour section can be at least 5%, at least 10%, at least 15%, at least 20%, at least 25%, at least 30%, at least 40% or even at least 50% larger than the radius of curvature in the second guiding contour section. This can, for example,
only apply to a discrete radius of curvature at a specific longitudinal coordinate of the guiding contour sections,
apply to a subsection of the guiding contour sections in which the radius of curvature is constant,
apply to averaged radii of curvature in the guiding contour sections or
apply to all radii of curvature if the radius of curvature in the guiding contour sections changes continuously.

Alternatively or cumulatively, it is possible that the radius of curvature in the first guiding contour section decreases continuously or in steps in the direction of the longitudinal extension and with increasing distance from the rotor axis.

In principle, the connecting section can be constructed in any way. Preferably, the connecting section comprises a corrugated tube through which the different conduits, in particular connecting conduits, of the connecting section can extend. The corrugated tube serves, for example, to bundle the conduits, to protect the conduits and to guide and encapsulate the conduits.

For a particular proposal, the radius of curvature in the first guiding contour section becomes continuously smaller with increasing distance from the rotor axis. It is possible that this only applies to the first guiding contour section. Preferably, the radius of curvature in the second guiding contour section also becomes continuously smaller with increasing distance from the rotor axis.

As previously explained, the stresses on the connecting section in the guiding device are quite complex, which can also make the requirements for the design of the geometry of the guiding contour sections complex. For one design of the continuous flow centrifuge, a radius of curvature is dimensioned at the different coordinates of the longitudinal extension in the first guiding contour section and/or in the second guiding contour section in such a way that a stress on the connecting section guided in the compensating rotor guiding device is constant at these or all coordinates of the longitudinal extension or only varies by a maximum of ±20%, a maximum of ±15%, a maximum of ±10% or a maximum of ±5%. The stress that should remain constant or should only vary by the specified percentage is determined by superimposing two different stress components:
a tensile stress on the connecting section at the coordinates of the longitudinal extension, which results from the centrifugal force due to the subsection of the connecting section that is arranged radially on the outside of the coordinate of the longitudinal extension;
rotating bending stress of the connecting section at the coordinates of the longitudinal extension, which results from the rotating bending of the connecting section in accordance with the curvature of the same.

On the one hand, this design is based on the assumption that the two stress components mentioned determine the strength of the connecting section, whereby on the one hand a safety margin can be taken into account via the specified percentage variation ranges and on the other hand other biases that occur (friction, heating, wear, . . . ) can be taken into account.

For an alternative or cumulative design criterion, the radius of curvature is dimensioned in such a way that the stress due to the aforementioned two stress components over the longitudinal extension of the connecting section in the first guiding contour section and/or in the second guiding contour section is at least a predetermined percentage smaller than a permissible stress on the connecting section. For example, a maximum static bending stress can be specified by the manufacturer for the use of a corrugated tube in the connecting section, so that in this case the resulting stress determined from the two stress components is smaller by a fixed percentage than this bending stress specified by the manufacturer. A further permissible stress, to which the stress determined from the stress components is related as a percentage, can be a maximum dynamic tensile and/or bending stress or a predetermined tensile strength or fatigue strength of a component of the connecting section or of the entire connecting section.

Another solution to the object is a compensating rotor guiding device designated to be used for a continuous flow centrifuge as previously explained. The compensating rotor guiding device comprises a guiding tube or consists of a guiding tube, wherein the guiding tube comprises a guiding contour with a first guiding contour section and a second guiding contour section. The first guiding contour section comprises a curvature in a first direction, while the second guiding contour section comprises a curvature in a second direction, which is oriented opposite to the first direction. The first guiding contour section and the second guiding contour section are connected to each other by an intermediate section preferably oriented radially to the rotor axis or by a turning section. The first guiding contour section has a smaller distance from the rotor axis than the second guiding contour section. The radius of curvature in the first guiding contour section is larger than the radius of curvature in the second guiding contour section. It is possible that in the guiding tube the radius of curvature in the first guiding contour section becomes smaller in the direction of the end section facing the second guiding contour section, which can occur in steps or continuously.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated geometries and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to the features mentioned in the claims, or these features may be the only features of the subject claimed by the respective claim.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiments shown in the figures.

FIG. 1 highly schematically shows a continuous flow centrifuge with a connecting section (without an illustration of the guiding device) in a three-dimensional semi-longitudinal section.

FIG. 2 shows a connecting section in a guiding device, as can be used in a continuous flow centrifuge as shown in FIG. 1.

FIGS. 3 to 5 show tables for dimensioning the radii of curvature of a guiding tube of a compensating rotor guiding device.

FIG. 6 shows an exemplary progression of a radius of curvature of a guiding tube of a compensating rotor guiding device as well as a pulling force resulting from the centrifugal force as a function of the distance from a rotor axis.

FIG. 7 schematically shows for an auxiliary consideration for the determination of a pulling force acting on a longitudinal subsection of a tube or hose of the connecting section at a coordinate of the longitudinal extension and at a distance from a rotor axis as a result of a centrifugal force.

### DETAILED DESCRIPTION

In the figures, components or features that correspond or are similar are sometimes identified with the same reference signs, whereby these components or features may then be distinguished from one another by the additional letter a, b, . . . . In this case, reference can be made to these components or features with or without the additional letter, whereby one of the components or features, several or all of the components or features can be addressed in this case.

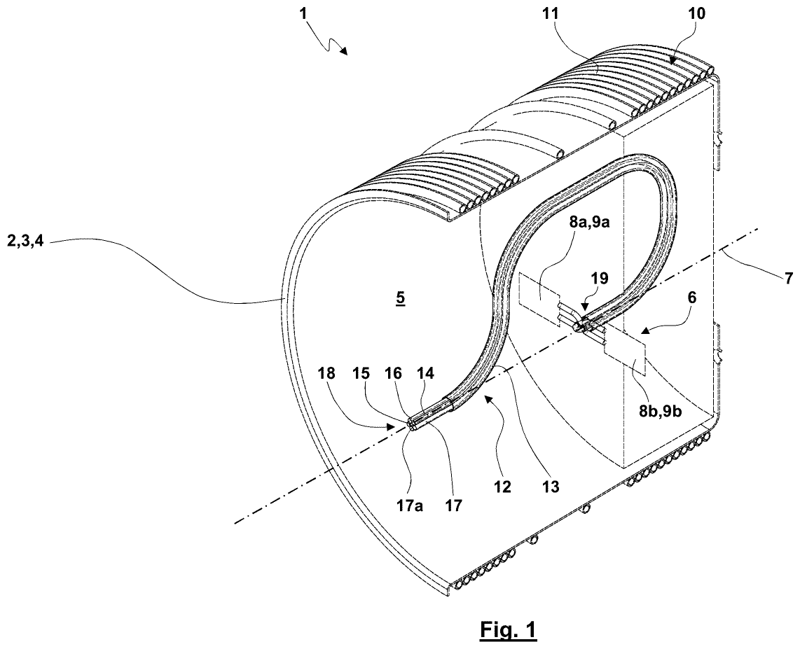

FIG. 1 highly schematically shows a three-dimensional representation of a continuous flow centrifuge 1 in a semi-longitudinal section. The continuous flow centrifuge 1 has a housing 2 and, in particular, a vessel 3 with a wall 4. The wall 4 of the vessel 3 defines a rotor chamber 5 in which a rotor 6 is rotated about a rotor axis 7 at a rotor speed. Of the rotor 6, only receptacles 8a, 8b (here two receptacles 8a, 8b, although any other number of receptacles 8 may also be present) arranged in the centrifugation chamber of the rotor 6 are shown in the schematic representation according to FIG. 1, which may be blood bags 9 for example or any other receptacles. The receptacles 8 are arranged evenly distributed in the circumferential direction around the rotor axis 7 and have the same distance from the rotor axis 7.

The continuous flow centrifuge 1 comprises a rotor chamber temperature control circuit 10, of which only a rotor chamber temperature control loop 11 is shown in FIG. 1. The rotor chamber temperature control loop 11 is integrated into the wall 4 of the vessel 3 and winds around the rotor axis 7 and the rotor chamber 5 with several windings.

FIG. 1 also shows a connecting section 12 (also covering a connecting strand or so-called umbilical). The connecting section 12 comprises a flexible hose or a flexible tube 13, which is in particular a corrugated tube. A temperature control supply conduit 14 and a temperature control discharge conduit 15, which can be used for temperature control and cooling of the connecting section, optionally extend through the hose or tube 13. Two connecting conduits 16, 17 extend through the hose or tube 13, through which the media flow in different directions during the different operating phases of the centrifugation process. In one end section 18 the connecting section 12 is attached to the housing 2 or a wall 4 of the vessel 3, while in another end section 19 the connecting section 12 is attached to the rotor 6 and is twisted with it.

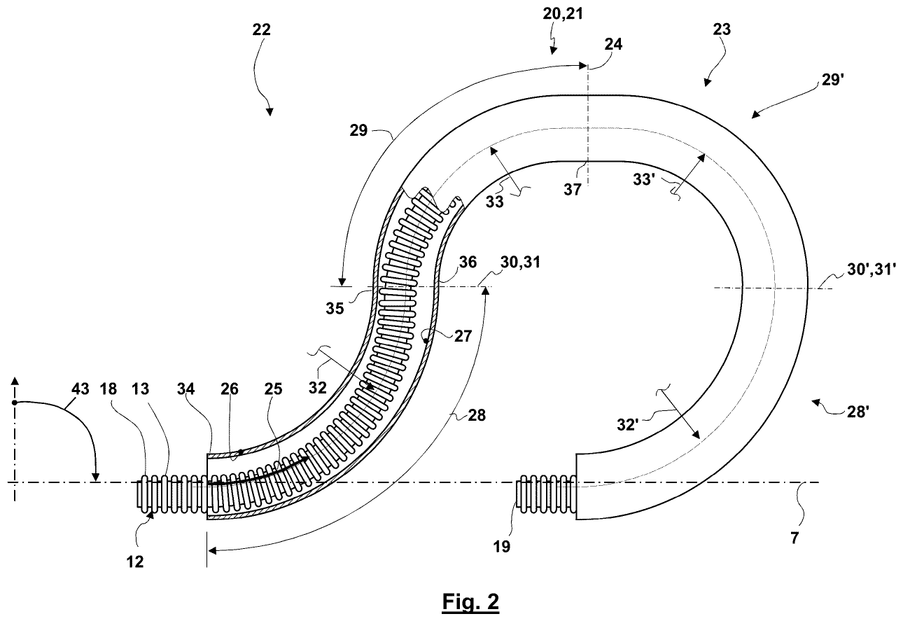

A compensating rotor also rotates around the rotor axis 7, the rotational speed of the compensating rotor being half the speed of the rotor 6. The compensating rotor comprises a compensating rotor guiding device 20, which is shown in FIG. 2 and is embodied as a guiding tube 21 here. The guiding tube 21 comprises two guiding tube halves 22, 23, which are separated from each other by the dotted imaginary separating line 24. The guiding tube 21 comprises a constant circular ring-shaped cross-section along a coordinate of the longitudinal extension 25, the coordinate of the longitudinal extension 25 being curved in different directions (as will be explained in more detail below). The connecting section 12 (which is embodied as a corrugated tube here) extends through the guiding tube 21. In both end sections of the guiding tube 21 the connecting section 12 extends out of the guiding tube 21 to enable it to be attached to the housing 2 or the rotor 6. There is radial play between an inner surface 26 of the guiding tube 21 and the outer surface of the connecting section 12, wherein the connecting section 12 can come into contact with the inner surface 26 of the guiding tube 21 on one side, depending on the curvature of the connecting section 12 and the stresses on it as explained above.

In the guiding tube half 22 the guiding tube 21 has a guiding contour 27, which is provided by the inner surface 26. The guiding contour 27 comprises a first guiding contour section 28 and a second guiding contour section 29, which are directly connected to each other via a turning section 30. For this embodiment the turning section 30 also forms an intermediate section 31, in the area of which the guiding tube 21 is oriented radially to the rotor axis 7. In the first guiding contour section 28 the guiding contour 27 (in particular the coordinate of the longitudinal extension 25 of the guiding tube 21) has a first radius of curvature 32, while the guiding contour 27 has a second radius of curvature 33 in the second guiding contour section 29. For the embodiment in FIG. 2 the first radius of curvature 32 is constant in the first guide section 28 and the second radius of curvature 33 is also constant in the second guide section 29, whereby the second radius of curvature 33 is smaller than the first radius of curvature 32. In the first guiding contour section 28 the curvature of the coordinate of the longitudinal extension 25 is counterclockwise, while the curvature reverses in the turning section 30 so that in the second guiding contour section 29 the curvature of the coordinate of the longitudinal extension 25 is clockwise. The guiding contour sections 28, 29 each extend over a circumferential angle of 90°. However, smaller circumferential angles are also possible, in which case the guiding tube 21 is not oriented radially to the rotor axis 7 in the turning section 30.

As can be seen in FIG. 2, one end section 34 of the first guiding contour section 28 is oriented (approximately) coaxially to the rotor axis 7, while the other end section 35 of the first guiding contour section 28 is oriented radially to the rotor axis 7. In the turning section 30 and the intermediate section 31, the facing end section 36 of the second guiding contour section 29 follows to the end section 35 in a flush way, the end section 36 being oriented radially to the rotor axis 7. In contrast, the other end section 37 of the second guiding contour section 29 is oriented parallel to the rotor axis 7, the guiding tube 21 having the maximum distance from the rotor axis 7 in this area. In principle, the second guiding tube half 23 can be embodied symmetrically to the separating line 24 of the first guiding tube half 22. For the illustrated embodiment, this mirror symmetry only applies to the second guiding contour section 29′, while the first guiding contour section 28′ in the second guiding tube half 23 follows to the second guiding contour half 29′ without mirroring so that in the direction of the coordinate of the longitudinal extension 25 both guiding contour sections 28′, 29′ are curved in the clockwise direction and together form a half ring with a radius of curvature 32′ that increases in the region of the turning section 30′ and intermediate section 31′ in the direction of the coordinate of the longitudinal extension 25.

For the embodiment according to FIG. 2, the guiding tube 21 can thus consist of two joined guiding contour parts, which are identical and each form the guiding contour sections 29, 29′, as well as two guiding tube parts which form the guiding contour sections 28, 28′ which may increase the number of the same parts for the production of the guiding tube 21. It can be understood, however, that it is also possible to manufacture the guiding tube 21 in one single piece, depending on the manufacturing process used.

The guiding contour sections 28, 29 shown in FIG. 2 are merely illustrated and explained by way of a non-limiting example.

For a first proposal, in contrast to FIG. 2 the radius of curvature 32 in the guiding contour section 28 is not constant. Rather, it decreases in steps or continuously along the coordinate of the longitudinal extension 25.

It is also possible that the radius of curvature 32 initially decreases continuously (for example only adjacent to the end 34), while the radius of curvature 32 then remains constant in the guiding contour section 28 or continues to decrease in steps.

For all embodiments, a constant radius of curvature 33, a radius of curvature 33 that decreases in steps or a radius of curvature 33 that decreases continuously in one subsection and remains constant or changes in steps in another subsection can then be used in the second guiding contour section 29.

In the following, an exemplary option for determining a progression of the radius of curvature 32, 33 of the guiding tube 21 of the compensating rotor guiding device 20 is explained. Here, a simplified calculation with simplifying assumptions is explained here and the embodiments are not intended to be limited to the radii of curvature determined in this way. For the following exemplary calculation, the assumption is made that the hose or (corrugated) tube 13 follows the course of the guiding contour 27 of the guiding tube 21. As can also be seen in FIG. 2, this is not actually the case so that for a calculation with increased accuracy the course of the hose or (corrugated) tube 13 in the guiding tube 21 must be determined and then a corresponding calculation of the radii of curvature for this course must be made.

The exemplary calculation is based on a hose or (corrugated) tube 13 comprising a diameter D of 0.013 m and whose spring constant is c=5,000 [pulling force in N/elongation] when subjected to a tensile force acting in the longitudinal direction. This spring constant c can be specified by the manufacturer or determined using a simple tensile test.

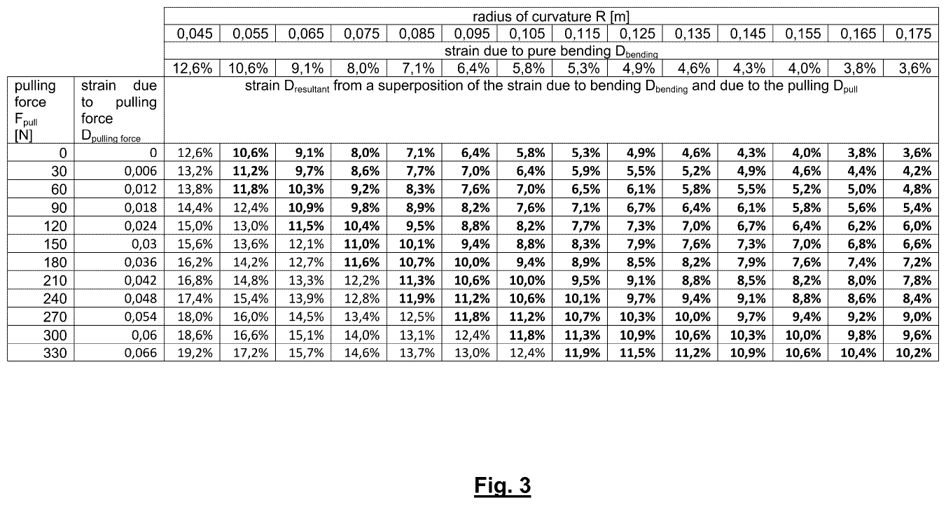

In the table in FIG. 3, for different pulling forces Fₚᵤₗₗ acting on the hose or (corrugated) tube 13 in the range from 0 N to 330 N the strain D_{tensile force} of the hose or (corrugated) tube 13 resulting from the spring constant c

D_{tensile force}=Fₚᵤₗₗ/c
have been calculated (see first and second columns).

If the hose or tube is bent with a radius of curvature R, the material area on the outside with regard to the curvature is stretched, while the material area on the inside is compressed. The strain D_{bending} as a result of the bending in the radially outer area can be determined via

$${D}_{bending} = 0.5 D / ( R + 0.5 D ) .$$

In the table in FIG. 3, the fourth line shows the strain D_{bending} resulting from this bending for the radii of curvature R in the range from 0.45 m to 0.175 m shown in the second line.

If during operation the strain due to bending D_{bending} and the strain due to the pulling force D_{pulling force} are superimposed in the material area stretched to the maximum as a result of bending, the strain due to pulling force D_{pulling force} on the one hand and the strain for pure bending D_{bending} must be added in the table in FIG. 3, resulting in the specified resultant strains Dᵣₑₛᵤₗₜₐₙₜ.

If the radius of curvature R is to be designed in such a way that the resultant strain Dᵣₑₛᵤₗₜₐₙₜ resulting from the superposition is always less than 12%, only the radii of curvature R for which the resultant strains Dᵣₑₛᵤₗₜₐₙₜ are highlighted in bold in the table in FIG. 3 can be considered. This means that for a resultant strain Dᵣₑₛᵤₗₜₐₙₜ of less than 12%
the radius of curvature R can be 0.055 m for pulling forces of 0 N to 60 N (i.e. for a coordinate of the longitudinal extension 25 that is far away from the rotor axis 7 and at which the guiding tube 21 is preferably oriented parallel to the rotor axis 7 and where thus no centrifugal force acts),
the radius of curvature R can be 0.065 m for pulling forces of 90 N to 120 N,
the radius of curvature R can be 0.075 m for a pulling force of 150 N to 180 N,
for pulling forces of 210 N to 240 N the radius of curvature R can be 0.085 m,
the radius of curvature R can be 0.095 m for a pulling force of 270 N,
the radius of curvature R can be 0.105 m for a pulling force of 300 N,
for a pulling force of 330 N (which is effective e. g. at a coordinate of the longitudinal extension 25 of the guiding tube 21 in the guiding contour section 8 in the end region 34), the radius of curvature R can be 0.115 m.

(A corresponding calculation can also be made with smaller steps of pulling force or with a continuous change in pulling force).

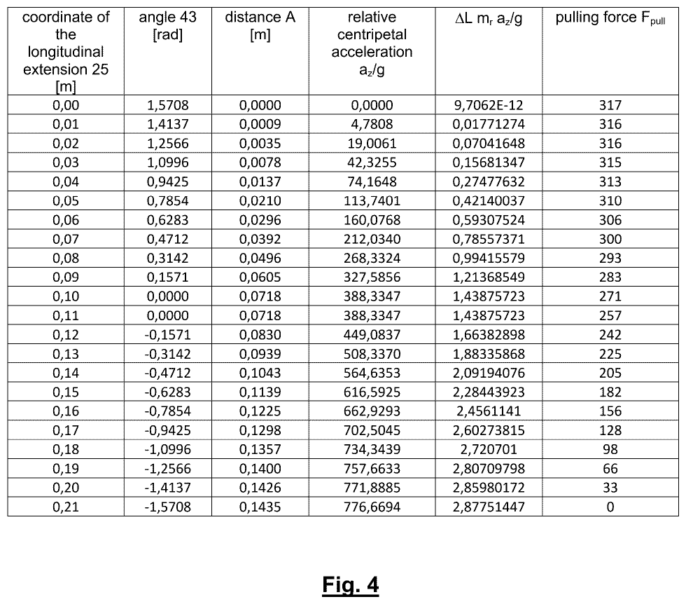

In the table according to FIG. 4, a length along the coordinate of the longitudinal extension 25 of the guiding tube 21 from the rotor axis 7 in the range from 0 m to 0.21 m is indicated in the first column, which corresponds to the length up to the separating line 24. In the second column, an angle 43 of a longitudinal section of the connecting section 12 arranged at the coordinate of the longitudinal extension 25 is indicated in radians relative to an orientation radial to the rotor axis 7. At the coordinate of the longitudinal extension 0.00 m (i.e. at the entry into the guiding tube 21) the angle 43 is π/2, while the angle 43 is zero at the turning section 30 and is −π/2 at the end section 37.

If the simplifying assumption is made that the two guiding contour sections 28, 29 are curved in a quarter-circle with the same radii of curvature R, the angle 43 between these characteristic angles 43 can be calculated for the respective coordinate of the longitudinal extension 25 via

$$Angle 43 = π / 2 - ( π / 2 \times coordinate of the longitudinal extension 25 / R ) ,$$

where a constant radius of curvature R of 0.105 m has been assumed.

The distance A of a longitudinal section at the coordinate of the longitudinal extension 25 is then calculated using

$$A = R ( 1 - sin ( angle 43 ) ) ,$$

where the distance A in FIG. 4 is shown in the third column.

If it is e. g. assumed that the relative mass mᵣ of the connecting section 12 per length mᵣ=0.3705 kg/m, the relative centripetal acceleration at the respective coordinate of the longitudinal extension 25, which results from the quotient of the absolute centripetal acceleration a_{z} and the acceleration due to gravity g, can be calculated via

$${a}_{z} / g = {( 2 π n )}^{2} A / g ,$$

where n is the rotational speed of the compensating rotor guiding device 20 and for the exemplary calculation n is 36.67 revolutions/s (2200 rpm) and where g=9.813 m/s² applies.

If the relative centripetal acceleration a_{z}/g is multiplied by the relative mass mᵣ and the length ΔL of a longitudinal section with ΔL=0.01 m, the values given in column 5 of FIG. 4 are obtained. This column therefore shows the centrifugal force acting on the longitudinal section in relation to the length ΔL of a longitudinal section.

If the pulling force acting at a coordinate of the longitudinal extension 25 specified in the last column of the table in FIG. 4 is to be calculated from this, the centrifugal force acting on the respective longitudinal section 25 must be calculated (starting with the radially outermost longitudinal section at the coordinate of the longitudinal extension 25 of 0.21 m), which results from the product of the assigned value in the fifth column with g. The result must be multiplied by the cosine of the angle 43 according to the second column of the table in FIG. 4, since only the component according to the cosine of the angle 43 contributes to the pulling force acting in the direction of the longitudinal coordinate 25. With the transition to the next, radially inwardly adjacent longitudinal section 25, the previously determined pulling force is to be added to the pulling force calculated for the changed angle and the changed coordinate of the longitudinal extension 25 for this further longitudinal section 25. In the last column more and more pulling force components of the individual radially outwardly arranged longitudinal sections are added up in the direction of the coordinates of the longitudinal extension 25.

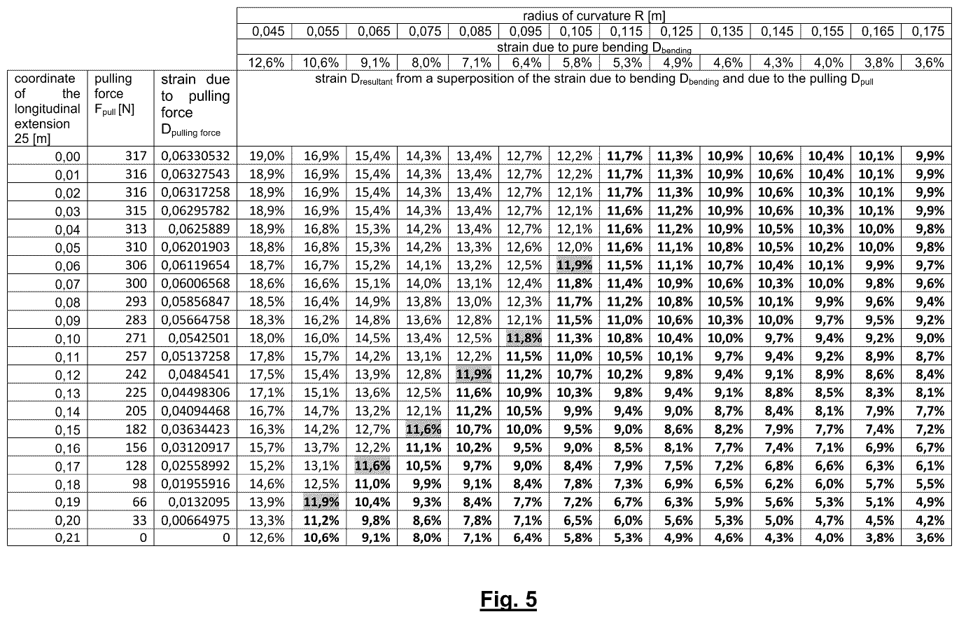

The pulling force determined in the last column of FIG. 4 at the respective coordinate of the longitudinal extension 25 is also entered in column 2 of FIG. 5. In the third column, the strain as a result of the pulling force D_{pulling force} has been calculated. According to FIG. 3, the resultant strains Dᵣₑₛᵤₗₜₐₙₜ are then calculated in the following columns for the superposition of the strain due to the bending D_{bending} for different radii of curvature R and the strain due to the pulling force D_{pulling force}.

If the design is also such that the resultant strain Dᵣₑₛᵤₗₜₐₙₜ should remain less than 12%, the radius of curvature R must be selected so that the resultant strains Dᵣₑₛᵤₗₜₐₙₜ shown in bold in FIG. 5 are obtained. This means that for
a coordinate of the longitudinal extension 25 in the range from 0.0 m to 0.05 m, the radius of curvature R can be 0.115 m,
a coordinate of the longitudinal extension 25 in the range from 0.06 m to 0.09 m, the radius of curvature R can be 0.105 m,
a coordinate of the longitudinal extension 25 in the range from 0.10 m to 0.11 m, the radius of curvature R can be 0.095 m.
a coordinate of the longitudinal extension 25 in the range from 0.12 m to 0.14 m, the radius of curvature R can be 0.085 m,
a coordinate of the longitudinal extension 25 in the range from 0.15 m to 0.16 m the radius of curvature R can be 0.075 m,
a coordinate of the longitudinal extension 25 in the range from 0.17 m to 0.18 m the radius of curvature R is 0.065 m and
a coordinate of the longitudinal extension 25 in the range from 0.19 m to 0.21 m, the radius of curvature R can be 0.55 m.

A calculation with a finer subdivision of the coordinates of the longitudinal extension 25 or a continuous calculation can also be performed. Excessive strains can also be avoided if larger radii of curvature than those specified in the list above are used at the respective coordinates of the longitudinal extension 25.

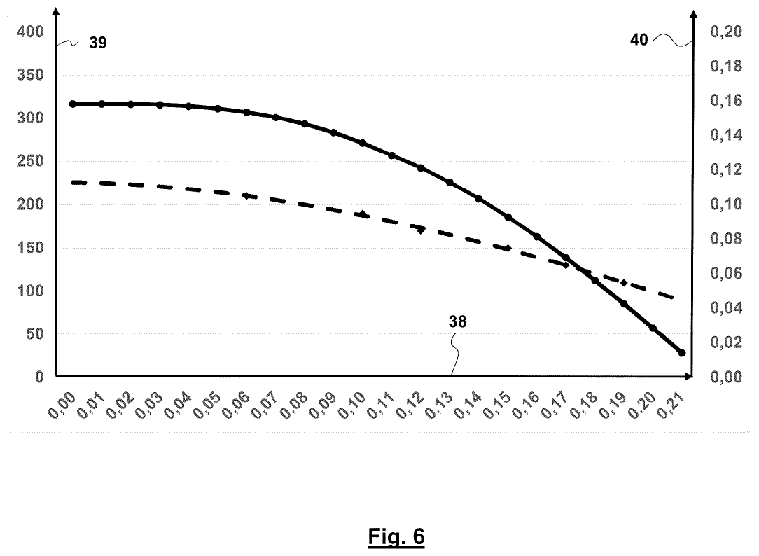

In FIG. 6, the acting pulling force 39 resulting from the centrifugal force is shown on the one hand (see the solid line which has been determined using a spline approximation of the individually determined pulling forces) in dependence on the coordinate 38 of the longitudinal extension 25 of the guiding tube 21 or the hose or (corrugated) tube 13. On the other hand, the radius of curvature R 40 is shown here (see dashed line which was also determined using a spline approximation), if the resultant strain Dᵣₑₛᵤₗₜₐₙₜ may have a maximum of 12%.

As explained above, the calculation method and the curve according to FIG. 6 are only shown as examples and simplifying and possibly falsifying assumptions have been made. As also mentioned before, the radius of curvature R actually used can be constant in subjections, in particular in the guiding contour section 28 on the one hand and the guiding contour section 29 on the other in deviation from the tables or from FIG. 6, provided that the radius of curvature R is greater in a subsection adjacent to the rotor axis 7 than in a subsection further away from the rotor axis 7. It is also possible to use progressions of the radius of curvature R that follow the progression in FIG. 6 in steps or in any other way.

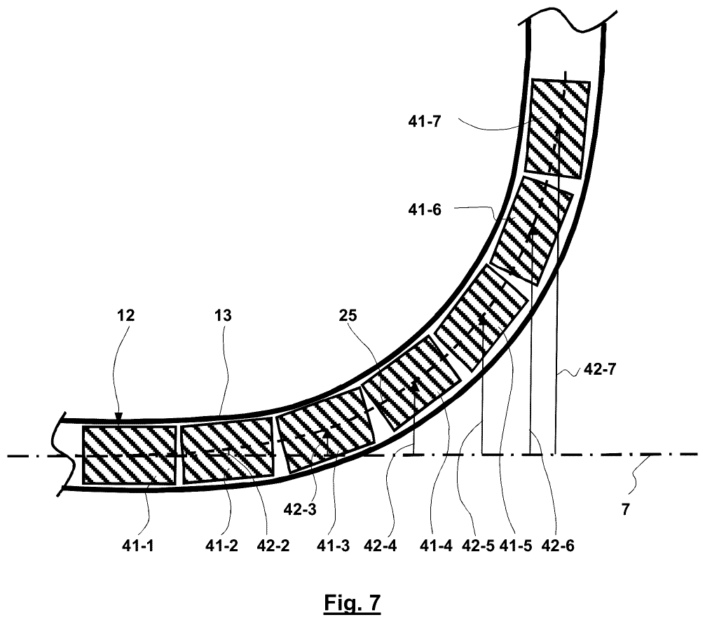

FIG. 7 shows a highly simplified (for example, neglecting the friction between the connecting section 12 and the hose or tube 13 as well as the support of the hose or tube 13 radially outwards) schematic representation for an auxiliary consideration. In this case, the connecting section 12 (in particular the hose or tube 13 and/or the conduits 14, 15, 16, 17) is divided into longitudinal sections 41 of equal size, which are distinguished from one another by the addition “−1”, “−2”. These longitudinal sections 41, comprising the same masses Δm due to the same sizes, each comprise different distances A₁, A₂, . . . from the rotor axis 7, which are marked with the reference sign 42 in FIG. 7 and are also distinguished from one another by the addition “−1”, “−2”, . . . . The centrifugal acceleration a_{z} acts on each longitudinal section 41, for which the following applies

a_{z}=(2πn)²A
where A is the respective distance 42 of the longitudinal sections 41 from the rotor axis 7 and n is the rotational speed of the compensating rotor guiding device 20 in [s⁻¹]. The centrifugal force F_{z} acting on the longitudinal sections 41 then results from

F_{z}=Δm a_{z}.

For each longitudinal section 41 only a force component of the centrifugal force F_{z} that is dependent on the angle 43 for the respective coordinate of the longitudinal extension leads to a pulling force acting in the direction of the coordinate of the longitudinal extension.

For the first longitudinal section 41-1 which is arranged coaxially to the rotor axis 7 the pulling force F_{pull, 1}, which acts on the longitudinal section 41-1, results (under the here chosen simplifying assumptions) from the sum of the centrifugal forces which must be held by the longitudinal section 41-1, i.e. from the sum of the force components of the centrifugal forces acting in the direction of the coordinate of the longitudinal extension 25, which act on the longitudinal sections 41-2, 41-3, . . . . Thus, for the pulling force F_{pull, 1}, which acts on the longitudinal section 41-1

$${F}_{pull , 1} = Δ m 4 {π}^{2} {n}^{2} ( {C}_{2} {A}_{2} + {C}_{3} {A}_{3} + {C}_{4} {A}_{4} + … ) ,$$

applies, while the pulling force F_{pull, 2} for the next longitudinal section 41-2 can be determined as follows:

$${F}_{pull , 2} = Δ m 4 {π}^{2} {n}^{2} ( {C}_{3} {A}_{3} + {C}_{4} {A}_{4} + … )$$

etc.

Here, C describes the conversion of the centrifugal force acting on the longitudinal section 41 into the force component acting in the direction of the coordinate of the longitudinal extension 25. Furthermore, another correction factor can also be taken into account in C, for example based on friction taken into consideration. The above simplified consideration shows that the acting pulling force Fₚᵤₗₗ is greatest at the longitudinal section 41-1 and that the acting pulling force and thus the stress becomes smaller with increasing distance of the longitudinal sections 41 from the rotor axis 7.

It may be possible to model the acting stresses more accurately, although this does not change the qualitative statement that an increase in fatigue strength can be achieved by increasing the radius of curvature for longitudinal sections 41 adjacent to the rotor axis 7.

Many variations and modifications may be made to the preferred embodiments of the invention without departing substantially from the spirit and principles of the invention. All such modifications and variations are intended to be included herein within the scope of the present invention, as defined by the following claims.

I claim:

1. A continuous flow centrifuge comprising
a) a centrifugation chamber,
b) a rotor arranged in the centrifugation chamber and being rotatable about a rotor axis at a rotor speed,
b) a connecting section with a first connecting conduit, via which a medium is supplied to the rotor during operation of the continuous flow centrifuge when the rotor rotates, and with a second connecting conduit, via which a medium is discharged from the rotor, wherein one end section of the connecting section is fixed to a housing and another end section of the connecting section is fixed to the rotor such that it is rotated with the rotor and
d) a compensating rotor guiding device which is rotated about the rotor axis at half the rotor speed and wherein the connecting section is guided to avoid twisting of the connecting section,
e) the compensating rotor guiding device providing a guiding contour,
f) the guiding contour comprising a first guiding contour section and a second guiding contour section,
g) the first guiding contour section comprising a curvature in a first direction and the second guiding contour section comprising a curvature in a second direction,
h) the first guiding contour section and the second guiding contour section being connected to each other by an intermediate section or turning section,
i) the first guiding contour section having a smaller distance from the rotor axis than the second guiding contour section,
j) a radius of curvature in the first guiding contour section being greater than a radius of curvature in the second guiding contour section.

2. The continuous flow centrifuge of claim 1, wherein the radius of curvature in the first guiding contour section becomes smaller in the direction of a coordinate of a longitudinal extension and becomes smaller with increasing distance from the rotor axis.

3. The continuous flow centrifuge according to claim 1, wherein the intermediate section is oriented radially to the rotor axis.

4. The continuous flow centrifuge according to claim 1, wherein the connecting section comprises a corrugated tube.

5. The continuous flow centrifuge according to claim 1, wherein the radius of curvature in the first guiding contour section becomes continuously smaller with increasing distance from the rotor axis.

6. The continuous flow centrifuge according to claim 5, wherein the radius of curvature in the second guiding contour section becomes continuously smaller with increasing distance from the rotor axis.

7. The continuous flow centrifuge according to claim 1, wherein the radius of curvature in the second guiding contour section becomes continuously smaller with increasing distance from the rotor axis.

8. The continuous flow centrifuge according to claim 1, wherein in at least one of the first guiding contour section and the second guiding contour section a radius of curvature at different or all coordinates of a longitudinal extension is dimensioned in such a way that a stress on the connecting section at coordinates of the longitudinal extension resulting from a superposition of
a) a tensile stress of the connecting section at the respective coordinates of the longitudinal extension resulting from a centrifugal force caused by a longitudinal section of the connecting section arranged radially outwardly of the respective coordinate of the longitudinal extension and
b) a rotating bending stress of the connecting section at the respective coordinates of the longitudinal extension, which results from a rotating bending of the connecting section corresponding to the radius of curvature,
is constant over the longitudinal extension or varies by a maximum of ±20%.

9. The continuous flow centrifuge according to claim 1, wherein in at least one of the first guiding contour section and the second guiding contour section a radius of curvature at different or all coordinates of a longitudinal extension is dimensioned in such a way that a stress on the connecting section at coordinates of the longitudinal extension resulting from a superposition of
a) a tensile stress of the connecting section at the respective coordinates of the longitudinal extension resulting from a centrifugal force caused by a longitudinal section of the connecting section arranged radially outwardly of the respective coordinate of the longitudinal extension and
b) a rotating bending stress of the connecting section at the respective coordinates of the longitudinal extension, which results from a rotating bending of the connecting section corresponding to the radius of curvature,
is a predetermined percentage less than a permissible stress of the connecting section.

10. A compensating rotor guiding device comprising a guiding tube, wherein the guiding tube comprises a guiding contour which has a first guiding contour section and a second guiding contour section, wherein
a) the first guiding contour section comprises a curvature in a first direction and the second guiding contour section comprises a curvature in a second direction,
b) the first guiding contour section and the second guiding contour section are connected to each other by an intermediate section or a turning section,
c) the first guiding contour section has a smaller distance from a rotor axis than the second guiding contour section and
d) a radius of curvature in the first guiding contour section is greater than a radius of curvature in the second guiding contour section, wherein the compensating rotor guiding device is configured for use in a continuous flow centrifuge that comprises:
i) a centrifugation chamber,
ii) a rotor arranged in the centrifugation chamber and being rotatable about a rotor axis at a rotor speed, and
iii) a connecting section with a first connecting conduit, via which a medium is supplied to the rotor during operation of the continuous flow centrifuge when the rotor rotates, and with a second connecting conduit, via which a medium is discharged from the rotor, wherein one end section of the connecting section is fixed to a housing and another end section of the connecting section is fixed to the rotor such that it is rotated with the rotor, and wherein, when used in the continuous flow centrifuge, the compensating rotor guiding device is rotated about the rotor axis at half the rotor speed and wherein the connecting section is guided to avoid twisting of the connecting section.

11. The compensating rotor guiding device of claim 10, wherein the radius of curvature in the first guiding contour section becomes smaller in the direction of a coordinate of a longitudinal extension and becomes smaller with increasing distance from the rotor axis.

12. The compensating rotor guiding device according to claim 10, wherein the intermediate section is oriented radially to the rotor axis.

13. The compensating rotor guiding device according to claim 10, wherein the connecting section comprises a corrugated tube.

14. The compensating rotor guiding device according to claim 10, wherein the radius of curvature in the first guiding contour section becomes continuously smaller with increasing distance from the rotor axis.

15. The compensating rotor guiding device according to claim 10, wherein the radius of curvature in the second guiding contour section becomes continuously smaller with increasing distance from the rotor axis.

16. The compensating rotor guiding device according to claim 15, wherein the radius of curvature in the second guiding contour section becomes continuously smaller with increasing distance from the rotor axis.

17. The compensating rotor guiding device according to claim 10, wherein in at least one of the first guiding contour section and the second guiding contour section a radius of curvature at different or all coordinates of a longitudinal extension is dimensioned in such a way that a stress on the connecting section at coordinates of the longitudinal extension resulting from a superposition of
a) a tensile stress of the connecting section at the respective coordinates of the longitudinal extension resulting from a centrifugal force caused by a longitudinal section of the connecting section arranged radially outwardly of the respective coordinate of the longitudinal extension and
b) a rotating bending stress of the connecting section at the respective coordinates of the longitudinal extension, which results from a rotating bending of the connecting section corresponding to the radius of curvature,
is constant over the longitudinal extension or varies by a maximum of ±20%.

18. The compensating rotor guiding device according to claim 10, wherein in at least one of the first guiding contour section and the second guiding contour section a radius of curvature at different or all coordinates of a longitudinal extension is dimensioned in such a way that a stress on the connecting section at coordinates of the longitudinal extension resulting from a superposition of
a) a tensile stress of the connecting section at the respective coordinates of the longitudinal extension resulting from a centrifugal force caused by a longitudinal section of the connecting section arranged radially outwardly of the respective coordinate of the longitudinal extension and
b) a rotating bending stress of the connecting section at the respective coordinates of the longitudinal extension, which results from a rotating bending of the connecting section corresponding to the radius of curvature,
is a predetermined percentage less than a permissible stress of the connecting section.
